(19) United States
(12) Patent Application Publication
(10) Pub. No.: US 2019/0095525 A1
(43) Pub. Date: Mar. 28, 2019

(54) EXTRACTION OF EXPRESSION FOR NATURAL LANGUAGE PROCESSING

(71) Applicant: International Business Machines Corporation, Armonk, NY (US)

(72) Inventors: MASAYASU MURAOKA, TOKYO (JP); TETSUYA NASUKAWA, KAWASAKI-SHI (JP)

(21) Appl. No.: 15/717,044

(22) Filed: Sep. 27, 2017

(51) Int. Cl. G06F 17/30

(52) U.S. Cl. CPC G06F 17/30684; G06F 17/3028

(57) ABSTRACT

A computer-implemented method, a computer program product, and a computer system for extracting an expression in a text for natural language processing. The computer system reads a text to generate a plurality of substrings in which each substring includes one or more units appearing in the text. The computer system obtains an image set for the each substring, using the one or more units as a query for an image search system; wherein the image set includes one or more images. The computer system calculates a deviation in the image set for the each substring. The computer system selects a respective one of the plurality of the substrings as an expression to be extracted, based on the deviation and a length of each substring.

### BACKGROUND

The present invention relates generally to information extraction, and more particularly to a technique for extracting an expression in a text for natural language processing.

Named entity recognition (NER) is a process for identifying a named entity such as a person, a location, an organization, or a product in a text. The NER plays a role for natural language processing such as text mining in terms of its performance and applications. The named entities often include an unregistered character string in a dictionary. Especially, a compound word that is made up of a registered element and an unregistered element often cause an error in subsequent natural language processing.

Since new named entities are born one after another, it is difficult to prepare a comprehensive or exhaustive list of the named entities for the NER systems. The named entity may often be an individual, an organization, a product name, a technical term, or a loan-word, which can be found in an unfamiliar field or language. Recognizing such named entities appearing in a sentence helps to improve accuracy of subsequent natural language processing and to extend its application area. Generally, the named entity may be extracted from a text by leveraging linguistic information such as context around a word and a series of part-of-speech.

In relation to the named entity recognition, a patent literature (US20150286629) discloses a named entity recognition system to detect an instance of a named entity in a web page and classify the named entity as being an organization or other predefined class. In this technique, text in different languages from a multi-lingual document corpus is labeled with labels indicating named entity classes by using links between documents in the corpus. Then, the text from parallel sentences is automatically labeled with labels indicating named entity classes. The parallel sentences are pairs of sentences with the same semantic meaning in different languages. The labeled text is used to train a machine learning component to label text, in a plurality of different languages, with named entity class labels. However, in the technique disclosed in the literature, sources of data to train machine learning components of a named entity recognition system are limited to linguistic information such as a multi-lingual or monolingual corpus and parallel sentences.

### SUMMARY

In one aspect, a computer-implemented method for extracting an expression in a text for natural language processing is provided. The computer-implemented method includes reading a text to generate a plurality of substrings, each substring including one or more units appearing in the text. The computer-implemented method further includes obtaining an image set for the each substring, the image set including one or more images, using the one or more units as a query for an image search system. The computer-implemented method further includes calculating a deviation in the image set for the each substring. The computer-implemented method further includes selecting a respective one of the plurality of the substrings as an expression to be extracted, based on the deviation and a length of each substring.

In another aspect, a computer program product for extracting an expression in a text for natural language processing is provided. The computer program product comprises a computer readable storage medium having program code embodied therewith. The program code is executable to read a text to generate a plurality of substrings, each substring including one or more units appearing in the text. The program code is further executable to obtain an image set for the each substring, the image set including one or more images, using the one or more units as a query for an image search system. The program code is further executable to calculate a deviation in the image set for the each substring. The program code is further executable to select a respective one of the plurality of the substrings as an expression to be extracted, based on the deviation and a length of each substring.

In yet another aspect, a computer system for extracting an expression in a text for natural language processing is provided. The computer system comprises one or more processors, one or more computer readable tangible storage devices, and program instructions stored on at least one of the one or more computer readable tangible storage devices for execution by at least one of the one or more processors. The program instructions are executable to: read a text to generate a plurality of substrings, each substring including one or more units appearing in the text; obtain an image set for the each substring, the image set including one or more images, using the one or more units as a query for an image search system; calculate a deviation in the image set for the each substring; and select a respective one of the plurality of the substrings as an expression to be extracted, based on the deviation and a length of each substring.

### BRIEF DESCRIPTION OF THE SEVERAL VIEWS OF THE DRAWINGS

FIG. 1 illustrates a block diagram of a system for creating a named entity dictionary, in accordance with one embodiment of the present invention.

FIG. 2 is a schematic of an example of generating substrings from a sentence in the system shown in FIG. 1, in accordance with one embodiment of the present invention.

FIG. 3 is a schematic of an example of obtaining object labels for each substring in the system shown in FIG. 1, in accordance with one embodiment of the present invention.

FIG. 4 is a schematic of an example of obtaining groups for each substring for each substring in the system shown in FIG. 1, in accordance with one embodiment of the present invention.

FIG. 5 is a schematic of an example of selecting one or more strings from a plurality of candidate strings as named entities in the system shown in FIG. 1, in accordance with one embodiment of the present invention.

FIG. 6 is a schematic of another example of selecting one or more strings from a plurality of candidate strings as named entities in the system shown in FIG. 1, in accordance with one embodiment of the present invention.

FIG. 7 is a flowchart depicting a process for extracting a named entity from a text by leveraging image information with object recognition technique, in accordance with one embodiment of the present invention.

FIG. 8 is a flowchart depicting a process for extracting a named entity from a text by leveraging image information with object recognition technique, in accordance with another embodiment of the present invention.

FIGS. 9A-9D show examples recognized by a process for extracting a named entity from a text by leveraging image information with object recognition technique, in accordance with one embodiment of the present invention.

FIG. 10 is a diagram illustrating components of a computer system for implementing the named entity recognition, in accordance with one embodiment of the present invention.

### DETAILED DESCRIPTION

Now, the present invention will be described using particular embodiments, and the embodiments described hereafter are understood to be only referred to as examples and are not intended to limit the scope of the present invention.

Embodiments of the present invention are directed to computer-implemented methods, computer systems and computer program products for extracting/recognizing a named entity from a text written in a natural language.

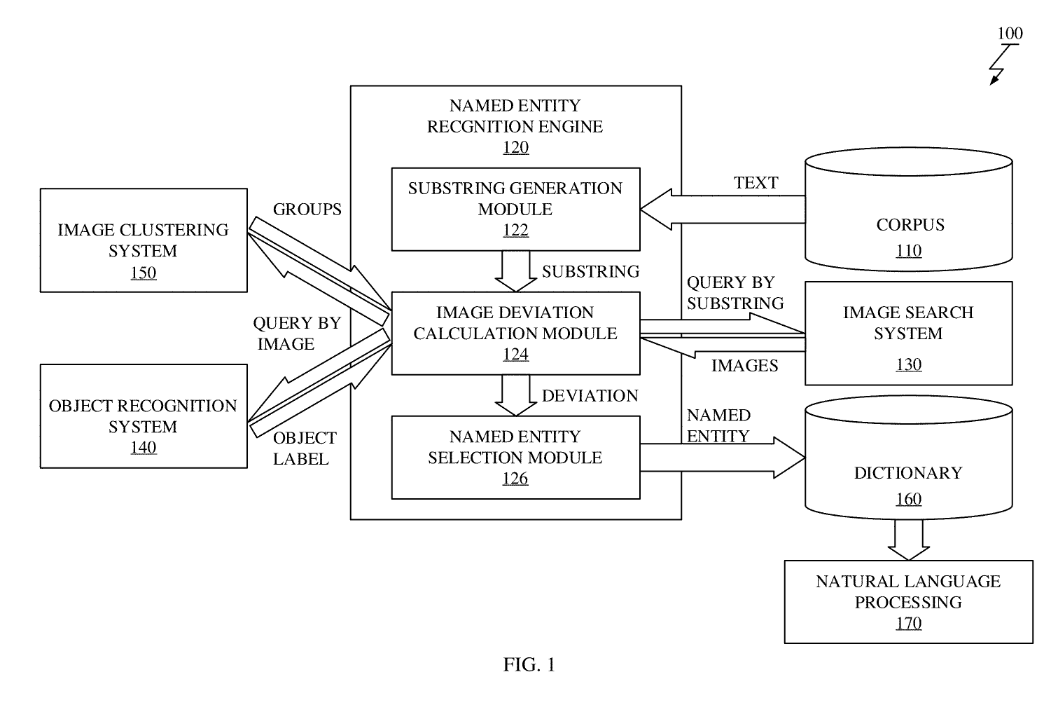

Named entity recognition (NER) is a process for extracting a named entity from a text written in natural language, in which the named entity may be a real-world object such as a person, a location, an organization, a product, etc. Referring to FIG. 1-FIG. 9, there are shown computer systems and process for extracting/recognizing a named entity from a text written in a natural language, according to one or more embodiments of the present invention.

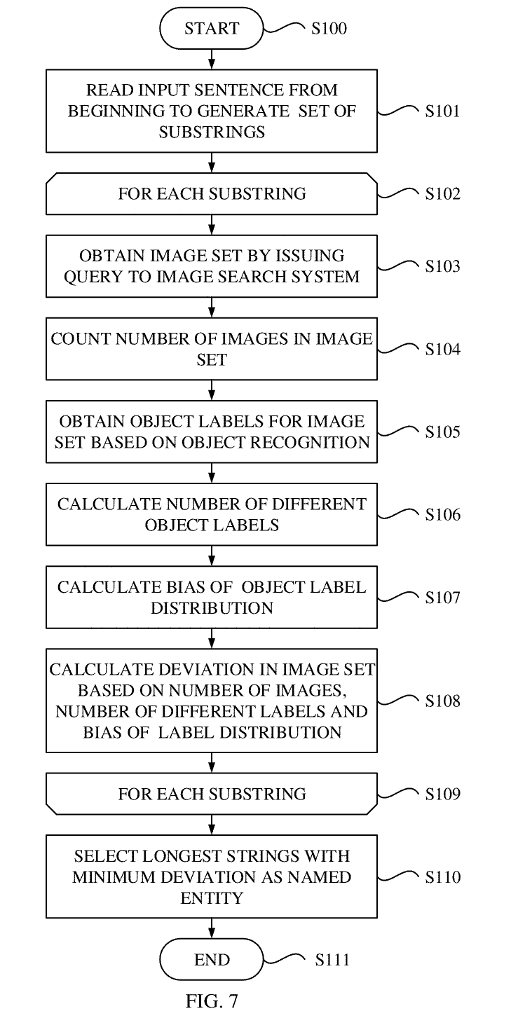

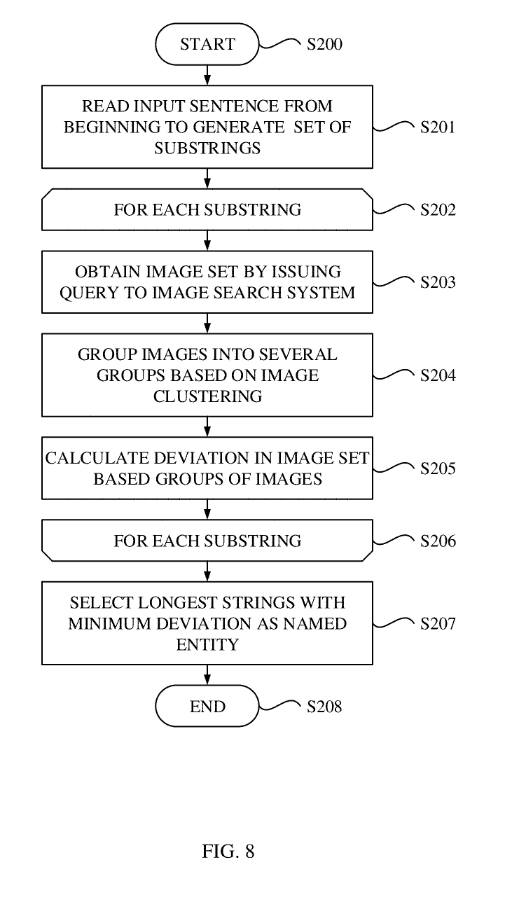

FIG. 1-FIG. 6 describe a computer system for creating a named entity dictionary, in accordance with one embodiment of the present invention. In the computer system, named entities are extracted from a collection of texts written in a variety of natural languages to build the named entity dictionary by leveraging image information with image analysis technique. FIG. 7 describes a method for extracting a named entity from a text written in a natural language by leveraging image information with object recognition technique, in accordance with one embodiment of the present invention. FIG. 8 describes a method for extracting a named entity from a text by leveraging image information with image clustering technique, in accordance with another embodiment of the present invention.

FIG. 1 illustrates a block diagram of a system 100 for creating a named entity dictionary, in accordance with one embodiment of the present invention. As shown in FIG. 1, the system 100 may include a corpus 110 for storing a collection of texts, a named entity recognition engine 120 for extracting/recognizing named entities from the texts, an image search system 130 for retrieving one or more images matched with a given query, an object recognition system 140 for classifying an object captured in a given image, an image clustering system 150 for clustering given images into several groups, and a dictionary store 160 for storing named entities recognized by the named entity recognition engine 120.

The corpus 110 may be a database that stores the collection of the texts, which may include a large amount of sentences written in a wide variety of languages, including English, Japanese, Indonesian, Finnish, Bulgarian, Hebrew, Korean, etc. The corpus 110 may be an internal corpus in the system 100 or an external corpus that may be provided by a particular organization or individual.

The named entity recognition engine 120 is configured to cooperate with the systems including the image search system 130, the object recognition system 140 and/or the image clustering system 150 to achieve named entity recognition/extraction functionality. At each stage of the named entity recognition, the named entity recognition engine 120 may issue a query to each of the systems 130, 140 and/or 150.

The image search system 130 is configured to retrieve one or more images matched with a given query. The image search system 130 may store indices of a large collection of images that is located over the worldwide computer network (internet) or is accumulated on a specific service such as social networking services. The image search system 130 may store relationships between each image and keywords extracted from a text associated with each image, and the query for the image search system 130 may be a string-based query.

The image search system 130 may receive a query from the named entity recognition engine 120, retrieve one or more images matched with the received query, and return an image search result to the named entity recognition engine 120. The image search result may include image data of each image (thumbnail or full image) and/or a link to each image. The image search system 130 may be an internal system in the system 100 or an external service that may be provided by a particular organization or individual through an appropriate application programming interface (API). Such external service may include search engine services, social networking service, and etc.

The object recognition system 140 is configured to classify an object captured in an image of a given query. The object recognition system 140 may receive a query from the named entity recognition engine 120, perform object recognition to identify one or more object labels appropriate for an image of the query, and return an object recognition result to the named entity recognition engine 120.

The query may include image data of the image or a link to the image. The object recognition result may include one or more object labels identified for the image of the query. Each object label may indicate a generic name (e.g., people, cat, automobile, etc.) and/or an attribute (e.g., age, gender, emotion, tabby patterns, paint color, etc.) of a real world object (e.g., humans, animals, machines, etc.) captured in the image of the query.

The object recognition, which is a process of classifying an object captured in an image into predetermined categories, can be performed by using any known object recognition/detection techniques, including feature based, gradient based, derivative based, and template matching based approaches. The object recognition system 140 may be an internal system in the system 100 or an external service that may be provided by a particular organization or individual through an appropriate API.

The image clustering system 150 is configured to group given images into several groups (or clusters). The image clustering system 150 may receive a query from the named entity recognition engine 120, perform image clustering on given images of the query, and return a clustering result to the named entity recognition engine 120. The query may include image data of the images or links to the images. The clustering result may include resultant group compositions of clustering. The image clustering may be based at least in part on feature vectors, each of which can be extracted by a feature extractor from each image.

Any known clustering algorithms such as aggregative hierarchical clustering (including group average method) and non-hierarchical clustering (such as k-means, k-medoids, x-means, etc.) can be applied to feature vectors of images. When an algorithm such as k-means, which has a fixed number of clusters as a parameter, is used, the appropriate number of the cluster can be determined by using any known criteria used in elbow method, silhouette method, etc. Also, the image clustering system 150 may be an internal system in the system 100 or an external service that may be provided by a particular organization or individual through an appropriate API.

The dictionary store 160 is configured to store a named entity dictionary that holds named entities recognized by the named entity recognition engine 120. The dictionary store 160 may be provided by using any internal or external storage device or medium to which the named entity recognition engine 120 can access.

The named entity recognition engine 120 performs a novel named entity recognition process by using the systems 130, 140 and/or 150 to recognize the named entities in the texts. Targets of the named entity recognition process may include any real-world objects having a proper name, such as a person, a location, an organization, a product, etc. In the embodiments, the targets may also include so-called unknown words.

In FIG. 1, a more detailed block diagram of the named entity recognition engine 120 is depicted. As shown in FIG. 1, the named entity recognition engine 120 includes a substring generation module 122 for generating a plurality of substrings from a given text as candidate strings for the named entities, an image deviation calculation module 124 for calculating deviation for images for each candidate string, and a named entity selection module 126 for selecting one or more strings from among the plurality of the candidate strings as the named entities to be extracted.

The substring generation module 122 is configured to read a text stored in the corpus 110 from the beginning one by one to generate a plurality of substrings as the candidate strings for the named entities. The text read by the substring generation module 122 may be a sentence written in a certain natural language, which may be known or unknown. The plurality of the substrings may be generated by enumerating single units appearing in the sentence and combinations of successive units appearing in the sentence. Thus, each substring may be made up of one or more successive units that appear in the sentence. Note that the unit is a word if there is a word divider in the sentence as written in English, or a character if there is no word divider in the sentence as written in Japanese. Also, the unit is a character if there is word divider in the sentence but there exists ambiguity as to how to give a word divider according to individual style as written in Korean. The plurality of the substrings generated by the substring generation module 122 includes at least a part of a power set of a set of words or characters appearing in the sentence.

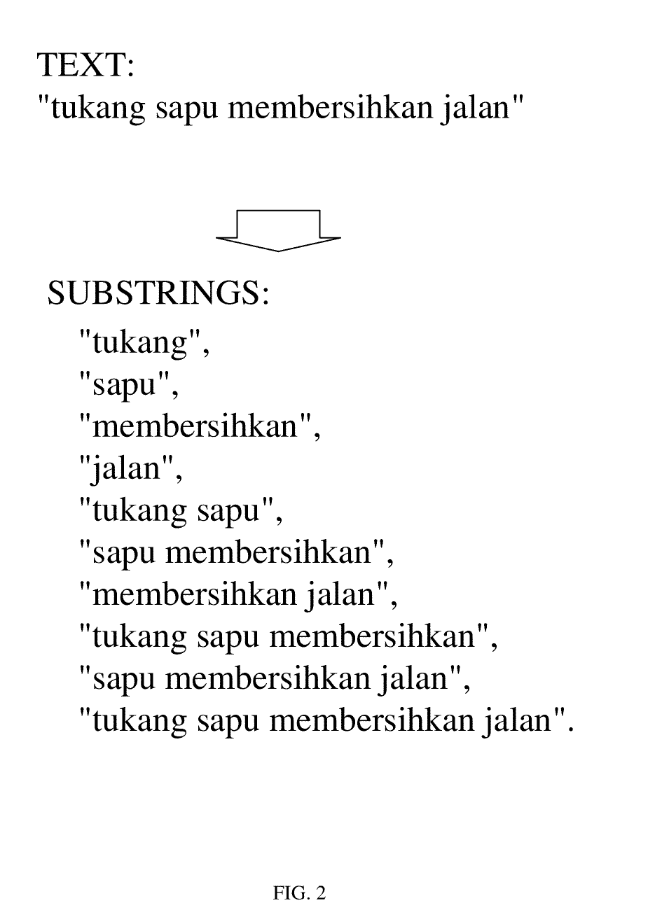

FIG. 2 is a schematic of an example of generating substrings from a sentence in the system shown in FIG. 1, in accordance with one embodiment of the present invention. In FIG. 2, a way of generating substrings from an exemplary sentence is described. The example in FIG. 2 shows a sentence written in Indonesian. The exemplary sentence “tukang sapu membersihkan jalan” includes four successive words divided by spaces. Thus, the string of the sentence may be made up of a set of four words appearing in the sentence and the power set of the set of the words may include at least ten substrings: four single words, three concatenation strings of successive two words with a space, two concatenation strings of successive three words with spaces, and one concatenation string of successive four words with spaces. Note that there also exists a null string and concatenation strings of distant words (e.g., “tukang jalan”) in the power set. However, the null string and the concatenation strings of the distant words can be excluded from the candidate strings to avoid extra processing, in a particular embodiment. In this example, ten substrings is generated as the candidate strings for the named entities, by the substring generation module 122 from the exemplary sentence.

Note that the length (the number of the units) of the substring can be limited by an appropriate maximum in a particular embodiment. In other embodiment, the length of the substring can be limited when there is no response from other systems by processing the substrings in ascending order of length.

Referring back to FIG. 1, the image deviation calculation module 124 is configured to obtain an image set including one or more images that relate to each candidate string (substring), from the image search system 130. The image set may be obtained by using one or more words or characters in each candidate string as a query for the image search system 130. In the exemplary embodiment, all words or characters in each candidate string are used as a query for the image search system 130. Modifications of the candidate string, such as addition of a search operator (e.g., surrounding candidate string with double quotes, concatenating plural words by a symbol), capitalization, and conversion between singular and plural forms, may also be contemplated to create the query for the image search system. In a particular embodiment, the query may request an exact match with the candidate string. In other particular embodiment, the query may allow a partial match with the candidate string.

The image deviation calculation module 124 is also configured to obtain an analysis result regarding the one or more images for each candidate string from the object recognition system 140 and/or the image clustering system 150. The analysis results may be obtained by using one or more images obtained for each candidate string at least in part as a query for the object recognition system 140 and/or the image clustering system 150. The image deviation calculation module 124 is further configured to calculate a deviation in the image set for each candidate string based at least in part on the analysis result obtained for the candidate string. Note that the deviation for each candidate string is a measure of variation of images and/or bias of images in the image set.

The analysis result obtained from the object recognition system 140 may include one or more object labels recognized for each image in the image set. The object labels recognized for each image in the image set are aggregated for each candidate string. The object labels obtained for each candidate string can be used to calculate the deviation for each candidate string. When using the object recognition system 140, the image deviation calculation module 124 can estimate a type (e.g., person, building, city, etc.) of the named entity by using the one or more object labels obtained for the candidate string that is selected as the named entity.

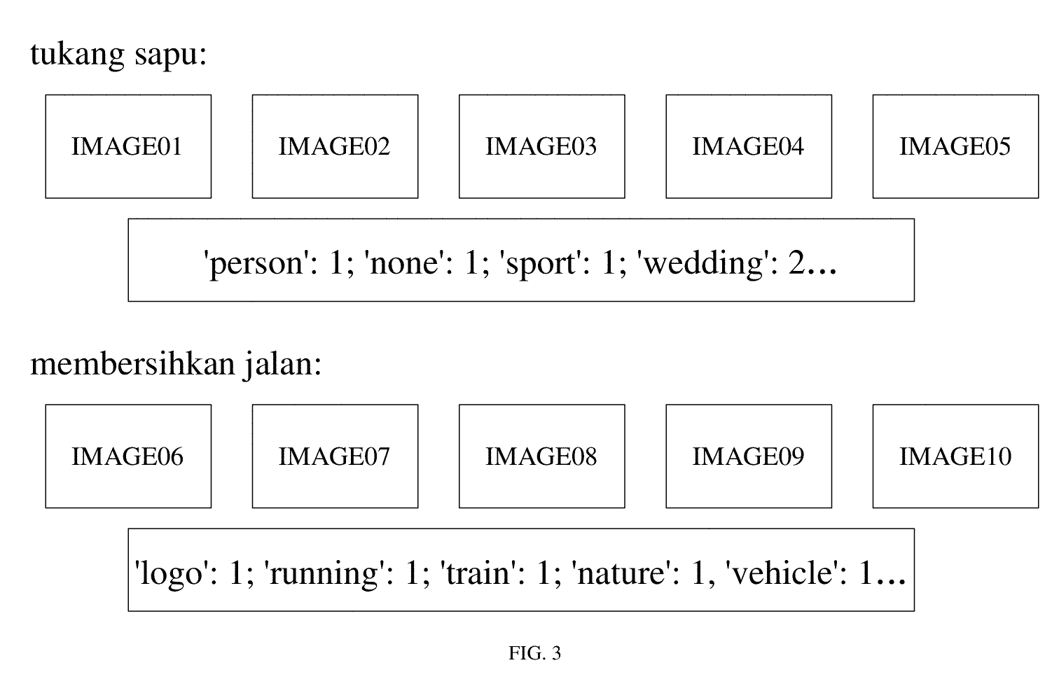

FIG. 3 is a schematic of an example of obtaining object labels for each substring in the system shown in FIG. 1, in accordance with one embodiment of the present invention. In FIG. 3, a way of obtaining object labels for each substring is described. In FIG. 3, schematic examples for two substrings “tukang sapu” and “membersihkan jalan” are representatively shown. As shown in FIG. 3, there are several images (image01 to image05 and images06 to image10) retrieved for each of the two substrings. Also, a plurality of object labels and its frequency are given for each substring.

In an embodiment, in order to calculate the deviation, the image deviation calculation module 124 may count the number of the existing images (EI) in the image set for each candidate string. The image deviation calculation module 124 may further calculate the number of different object labels (DOL) and bias of object label distribution (BOL) in the object labels for each candidate string. The number of the existing images (EI), the number of different object labels (DOL), and/or the bias of the object label distribution (BOL) for each candidate string may be used at least in part for calculating the deviation for each candidate string.

If a substring is too long or does not make sense, no or a few images is retrieved for the substring. Thus, the number of the existing image (EI) can be a good measure of the deviation in the image set for each candidate string. In a particular embodiment, the number of the images to be used for calculating the deviation may be limited by an appropriate maximum. Accordingly, the number of the existing images (EI) may be saturated at predetermined maximum.

If a substring represents a certain concept, there is a trend to have same object in multiple images in the image set. Thus, the number of the different object labels (DOL) can be a good measure of the deviation in image set for each candidate string. Furthermore, if there are multiple object labels obtained for each of two substrings, it can be considered that the substring has a greater bias better represents a concept. For example, let us assume that two labels (“person” and “statue”) are obtained for both of the two substrings but there are different label distributions, e.g., there are four “person” labels and one “statue” label for a first substring and there are three “person” labels and two “statue” labels for a second substring. In this example, the first substring with greater bias (four “person” labels and one “statue” label) can be expected to be more appropriate than the second substring with smaller bias (three “person” labels and two “statue” labels). Thus, the bias of the object label distribution (BOL) can be a good measure of the deviation in the image set for each candidate string. Note that the bias can be calculated as negative entropy for the set of the object labels as follows:

$$BOL = {\sum }_{i}^{n} {p}_{i} {log}_{2} {p}_{i} ,$$

where pᵢ denotes probability of appearance of label i (i=1, . . . , n).

The score of the deviation can be expressed as the following function (1):

Deviation Score=f(EI, DOL, BOL, [LS]) (1)

where LS represents the length of the substring counted by the number of words and the square brackets indicate that the variable is optional.

Note that the larger the score of the deviation, the better the candidate string represents one concept. In a particular embodiment, the score varies as follows. The score becomes larger as the number of the existing images (EI) becomes larger. The score becomes larger as the number of the different object labels (DOL) becomes smaller. The score becomes larger as the bias of the object label distribution (BOL) becomes larger. The score may become larger as the length of the substring (LS) becomes larger.

Referring back to FIG. 1, the analysis result obtained from the image clustering system 150 may include group compositions partitioned from the given images in the image set based on the image clustering. When using the image clustering system 150, the image deviation calculation module 124 may count the number of the groups after the clustering for each substring. The number of the groups counted for each substring may be used at least in part for calculating the deviation for each substring.

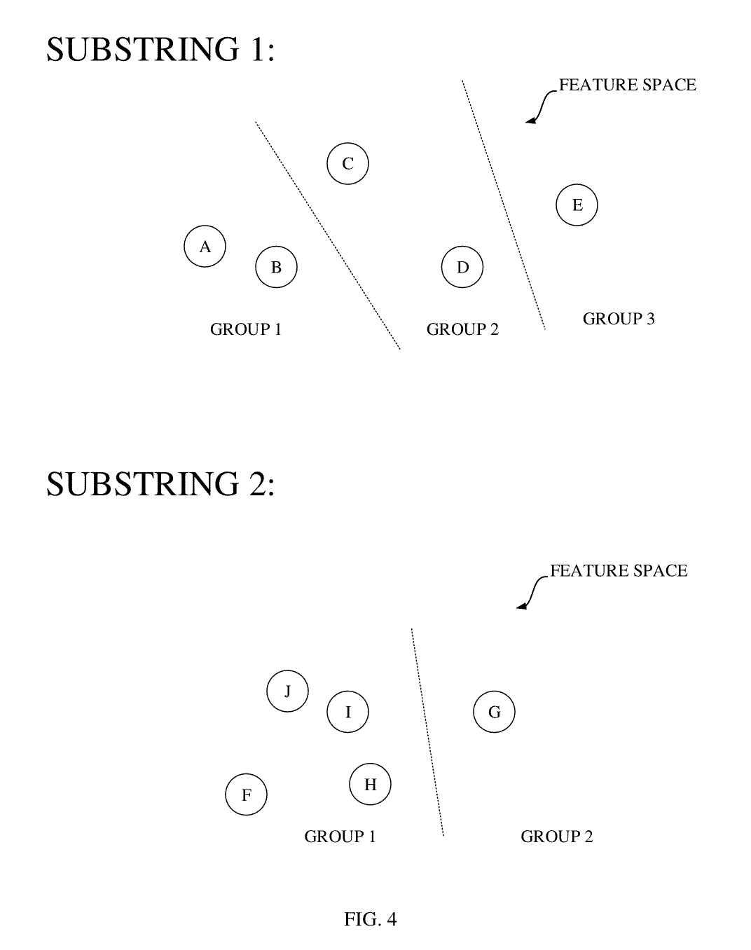

FIG. 4 is a schematic of an example of obtaining groups for each substring for each substring in the system shown in FIG. 1, in accordance with one embodiment of the present invention. In FIG. 4, a way of obtaining groups for each substring is described. In FIG. 4, examples for two schematic substrings “substring 1” and “substring 2” are representatively shown. As shown in FIG. 4, images in the image set for the “substring 1” are partitioned into three groups in the feature space. On the other hand, the images in the image set for the “substring 2” are partitioned into two groups. If a substring represents a certain concept, there is a trend to have similar feature in multiple images in the image set. Thus, the number of the groups after the clustering can be a good measure of the deviation in image set. The smaller the number of the groups, the better the substrings represents one concept.

Referring back to FIG. 1, the named entity selection module 126 is configured to select a string from the plurality of the candidate strings as a named entity by using at least in part the deviation and the length of each candidate strings. The selection of the string that can be considered as a named entity representing a concept may be done by using a predetermined rule for selection.

As described above, the plurality of the substrings may be scored such that the score becomes larger as the deviation for each substring becomes smaller. The longer (longest) substring having a larger score (maximum score) can be selected from among the plurality of the substrings. For example, if the substring “YORK” and the substring “NEW YORK” have same or almost same scores, the longer substring “NEW YORK” is selected as the named entity rather than the shorter substring “YORK”. Note that since it does not prevent a sentence from having plurality of named entities, one or more candidate strings are selected from the plurality of the candidate strings generated for the given sentence.

There are several ways of selecting one or more strings from the plurality of the candidate strings based on a predetermined rule for selection.

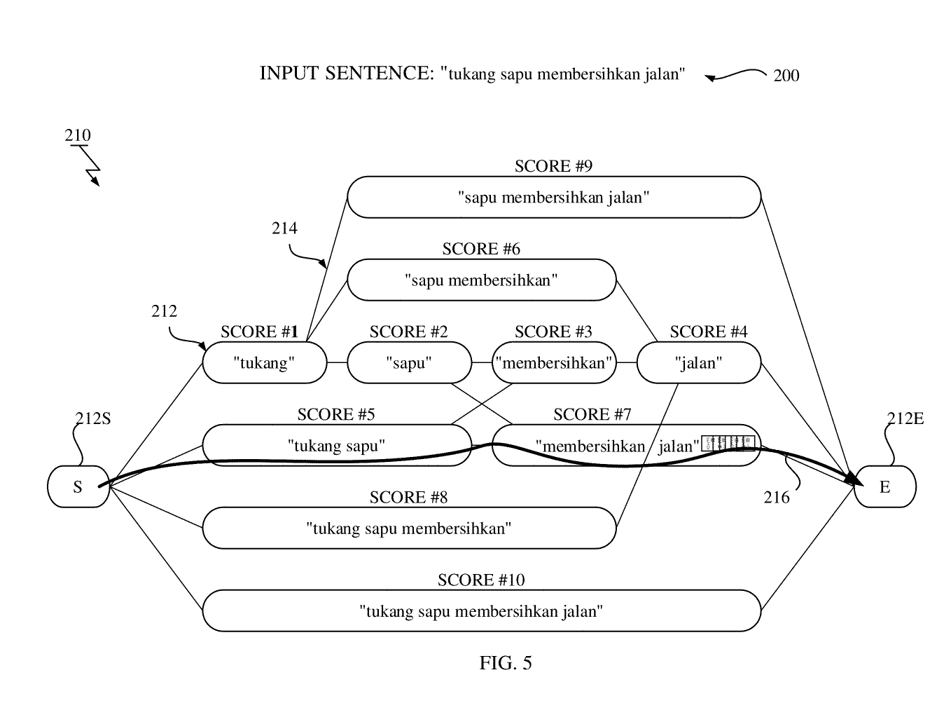

FIG. 5 is a schematic of an example of selecting one or more strings from a plurality of candidate strings as named entities in the system shown in FIG. 1, in accordance with one embodiment of the present invention. FIG. 5 describes a way of selecting one or more strings from a plurality of candidate strings as named entities. As shown in FIG. 5, an undirected graph 210 includes a plurality of nodes 212 and one or more edges 214 each associated with a pair of the nodes 212; each node 212 represents a substring obtained from input sentence 200, each edge 214 represents adjacency between substrings 212 in the input sentence 200; the nodes 212 includes a start and end nodes 212S and 212E representing the start and the end of the input sentence 200, respectively. A path 216 that maximizes sum of the deviation scores are obtained by Viterbi algorithm while using each deviation score (SCORE #1˜SCORE #10, each of which is the function of the length of the substring) for the substring as a weighting of each node. A series of substrings constituting the path 216 is selected as named entities. In this particular embodiment, the predetermined rule for selection may be a rule that selects one or more strings that are segmented from the input sentence 200 and maximize sum of the deviation scores from among the plurality of the candidate strings.

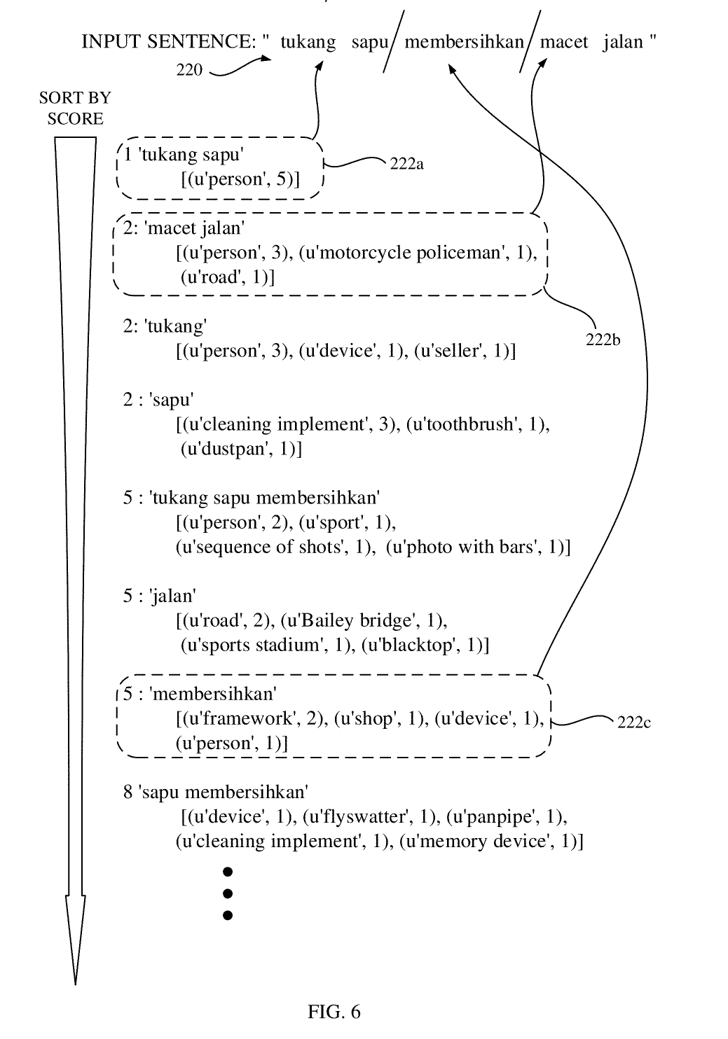

FIG. 6 is a schematic of another example of selecting one or more strings from a plurality of candidate strings as named entities in the system shown in FIG. 1, in accordance with one embodiment of the present invention. FIG. 6 describes another way of selecting one or more strings from a plurality of candidate strings as named entities. As shown in FIG. 6, a list of substrings obtained from an input sentence 220, each of which has a deviation score, is sorted by the deviation score in descending order. Note that if there are plural substrings having same deviation score, the list is sorted so that the one having longer length comes first. When substrings from the top of the list are picked up, a set of substrings 222a-222c that cover all words/characters in the input sentence 220 and do not overlap each other is extracted. In the example shown in FIG. 6, the substrings “tukang”, “sapu”, “tukang sapu membersihkan”, and “jalan” are skipped since these substrings overlap substrings “tukang sapu” and “macet jalan” that have been already picked up. Thus, in this particular embodiment, the predetermined rule for selection may be a rule that selects one or more strings that are segmented from the input sentence and are picked up in score descending order from among the plurality of the candidate strings.

The rule for selection is not limited to aforementioned particular examples. In other embodiment, the predetermined rule that simply selects one or more strings each having a deviation score that exceeds a predetermined threshold or one or more strings within the top N score.

In an embodiment, in order to improve accuracy of the named entity recognition, other information, such as the number of search results obtained for each substring, the title of the page associated with each image obtained for each substring, and/or a string included in each image obtained for each substring, may be taken into account to adjust the score for each substring in addition the deviation. The object recognition system 140 can provide such string included in each image based on OCR (Optical Character Recognition) technology.

In one embodiment, the score is configured to become larger as the number of the search result becomes larger by adding an additional term that evaluates the number of the search result into the aforementioned function (1). In another embodiment, in retrieving images matched with the given query, scope of search may be limited to pages that have candidate substring in the title of the page, which may affect the number of the existing images (EI) in the aforementioned function (1). In yet another embodiment, the score is configured to become larger as the number of images having a string identical/similar to the candidate substring becomes larger by adding an additional term that evaluates the number of the images including identical/similar string into the aforementioned function (1).

By performing aforementioned processing repeatedly for each sentence in the collection stored in the corpus 110, the named entity dictionary is built by using the named entities recognized by the named entity recognition engine 120.

As shown in FIG. 1, the system 100 further includes a natural language processing system 170 for performing natural language processing by using the dictionary that is built by the named entity recognition engine 120. The natural language processing performed by the natural language processing system 170 may include text mining, multilingual knowledge extraction, etc. Since a lot of named entities are registered in the named entity dictionary stored in the dictionary store 160, performance of the natural language processing is improved and extent of applications of the natural language processing is expanded.

In embodiments, the corpus 110, the named entity recognition engine 120, the image search system 130, the object recognition system 140, the image clustering system 150 the dictionary store 160, the substring generation module 122, the image deviation calculation module 124, and the named entity selection module 126 described in FIG. 1 may be implemented as, but not limited to, a software module including instructions and/or data structures in conjunction with hardware components, such as a processor, a memory, etc., a hardware module including electronic circuitry, or a combination thereof. the corpus 110, the named entity recognition engine 120, the image search system 130, the object recognition system 140, the image clustering system 150 the dictionary store 160, the substring generation module 122, the image deviation calculation module 124, and the named entity selection module 126 described in FIG. 1 may be implemented on a single computer system such as a personal computer, a server machine, or over a plurality of devices such as a computer cluster in a distributed manner.

FIG. 7 is a flowchart depicting a process for extracting a named entity from a text with object recognition, in accordance with one embodiment of the present invention. Note that the process shown in FIG. 7 may be executed by the named entity recognition engine 120 shown in FIG. 1, i.e., a processing unit that implements the named entity recognition. The process shown in FIG. 7 begins at step S100, in response to receiving a request for processing a sentence from an operator.

At step S101, the processing unit reads an input sentence from the beginning one by one to generate a set of substrings as candidate strings for named entities in a manner such that each substring includes one or more units appearing in the sentence. The unit in the substring may be a word or a character. At least a part of a power set of a set of words or characters in the sentence may be used as the substrings. The processing from step S102 to step S109 is performed iteratively for each substring generated at step S101.

At step S103, the processing unit obtains an image set including one or more images relating to each substring from the image search system 130 by issuing a query to the image search system 130. At step S104, the processing unit counts the number of the existing images (EI) in the image set obtained for each substring. Note that the number of the existing images may be limited in a particular embodiment.

At step S105, the processing unit obtains one or more object labels for the image set of each substring based on object recognition. An analysis result is obtained from the object recognition system 140. At step S106, the processing unit calculates the number of different object labels (DOL) obtained for each substring. At step S107, the processing unit calculates bias of object label distribution (BOL) obtained for each substring.

At step S108, the processing unit calculates a deviation in the image set for each substring by using at least in part the number of the existing images (EI) counted at step S104, the number of different object labels (DOL) calculated at step S106, and/or the bias of the object label distribution (BOL) calculated at step S107. The score of the deviation is calculated by the aforementioned formula (1) in a manner such that the score becomes larger as the deviation for each substring becomes smaller.

By repeatedly performing the processing from step S102 to step S109 for all substrings generated at step S101, the process may proceed to step S110. At step S110, the processing unit selects a substring from the plurality of the substrings generated at step S101 as a named entity using at least in part the deviation and the length of each substring. More specifically, one or more longer substrings with a larger score can be selected as the named entities from the plurality of the substrings. In an embodiment, the substring may be selected from the plurality of the substrings based on a predetermined rule that selects one or more strings that are segmented from the input sentence and maximize sum of the deviation scores from the plurality of the candidate strings. In step S110, a type of the named entity can be estimated by using the one or more labels obtained for the substring. Furthermore, in an embodiment, in step S110, the processing unit obtains the number of search results for each substring, the title of the page associated with each image for each substring, and/or a string in each image for each substring, and the processing unit adjusts the score using these information in addition to the deviation.

By repeatedly performing the process shown in FIG. 7 for each sentence in the given collection, a named entity dictionary is built.

FIG. 8 is a flowchart depicting a process for extracting a named entity from a text by leveraging image information with object recognition technique, in accordance with another embodiment of the present invention. Note that the process shown in FIG. 8 may be executed by the named entity recognition engine 120 shown in FIG. 1, i.e., a processing unit that implements the named entity recognition. The process shown in FIG. 8 begins at step S200, in response to receiving a request for processing a sentence from an operator as similar to the embodiment shown in FIG. 7.

At step S201, the processing unit reads an input sentence from the beginning one by one to generate a set of substrings as candidate strings for named entities. Similar to the process shown in FIG. 7, the processing from step S202 to step S206 is performed iteratively for each generated substring.

At step S203, the processing unit obtains an image set including one or more images for each substring from the image search system 130 by issuing a query to the image search system 130, similar to the process shown in FIG. 7.

At step S204, the processing unit groups the images in the image set for each substring into several group based on image clustering and counts the number of the groups for each substring. An analysis result obtained from the image clustering system 150 may indicate a plurality of groups of images partitioned from the given images in the image set.

At step S205, the processing unit calculates a deviation in the image set for each substring based at least in part on the number of the groups counted for each substring. By repeatedly performing the processing from step S202 to step S206 for all substrings generated at step S201, the process proceeds to step S207.

At step S207, the processing unit selects a substring from the plurality of the substrings as a named entity using at least in part the deviation and the length of each substring. More specifically, one or more longer substrings with a larger score are selected from among the plurality of the substrings.

By repeatedly performing the process shown in FIG. 8 for each sentence in the given collection, a named entity dictionary is built.

According to the embodiments, there is provided computer-implemented methods, computer systems, and computer program products for extracting/recognizing a named entity from a text written in a natural language.

According to the embodiments, even the text is written in an unfamiliar language and/or belongs to an unfamiliar field, a string corresponding to a named entity can be extracted from the text by leveraging image information associated with the string. The image information can represent in nature a concept without a linguistic expression and is associated with text in a worldwide computer network as collective knowledge. Thereby, it is helpful to improve accuracy of subsequent natural language processing and to extend its application area that is especially targeted for texts written in unfamiliar language and/or field.

For example, let us assume a sentence “I ATE A HAMBURGER IN NEW YORK” is given. In this example, if the system recognizes “NEW” as a concept, the system would make a mistake in a subsequent application such as text mining. In this case, the system is preferable to parse “NEW YORK” as one concept. Although this example is obvious, strings corresponding to named entities in even unfamiliar language and/or unfamiliar field can be preferably extracted from a text, regardless of whether the language of the text is known or unknown, according to the embodiments of the present invention. It does not require linguistic background knowledge such as parts of speech, meaning, etc. Recognizing named entities in unfamiliar fields and/or languages makes it possible to extract valuable information from unstructured text data by applying a subsequent natural language processing.

In the aforementioned exemplary embodiment, the named entity recognition has been described as an example of novel techniques for extracting an expression in a text. However, in other embodiments, target of the novel techniques is not limited to the named entities. Any particular linguistic expression including idioms, compound verbs, compound nouns, etc., which represent a certain concept that can be represented by a picture, a drawing, a painting, etc., can be targets of the novel techniques for extracting an expression in a text according to other embodiments of the present invention.

Experimental Studies:

A program implementing the process shown in FIG. 7 according to the embodiment was coded and executed for several given sentences. The sentences written in Indonesian, Finnish, Bulgarian, and Hebrew were used as input texts for a named entity recognition engine. Google™ Custom Search API and IBM™ Watson™ Visual Recognition API were used as the image search system and the object recognition system, respectively. The deviation in the image set for each substring was evaluated by the deviation score represented by the aforementioned function (1). A list of substrings obtained from each given sentence was sorted by the deviation score in descending order. While picking up substrings from the top of the list for each given sentence, a set of substrings that covered all words/characters in the given sentence and did not overlap each other was extracted as a set of named entities. The number of the images used for each substring was limited to five.

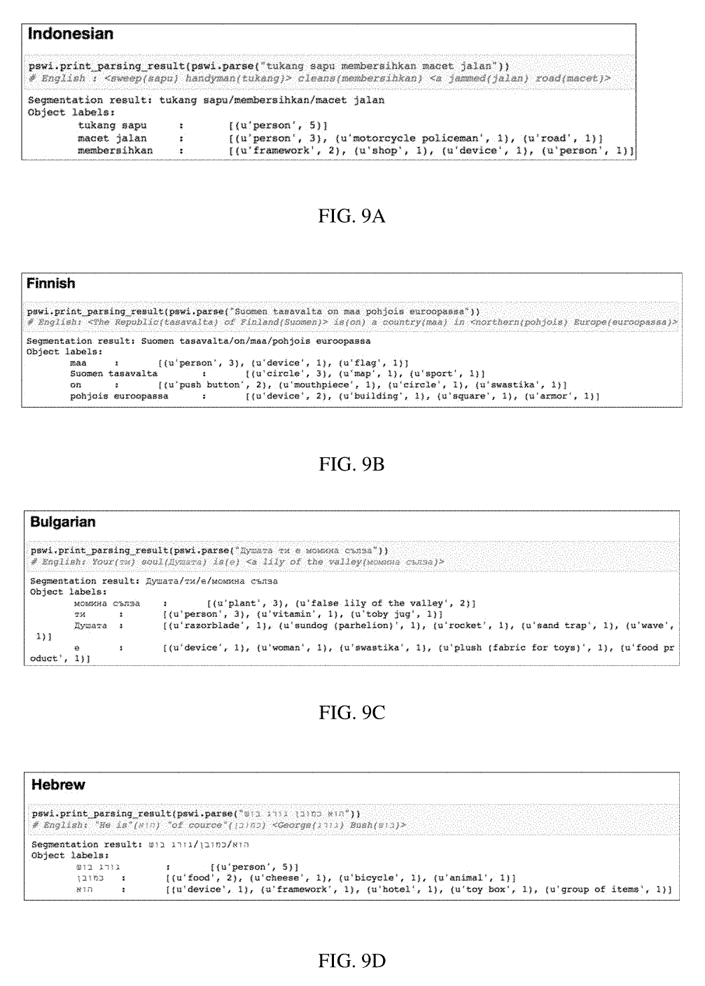

FIGS. 9A-9D show examples recognized by a process for extracting a named entity from a text by leveraging image information with object recognition technique, in accordance with one embodiment of the present invention. The example shown in FIG. 9A is a sentence written in Indonesian. As shown in FIG. 9A, the sentence in Indonesia was segmented into three substrings, each of which had corresponding object labels indicated in FIG. 9A. In this example, three substrings were recognized as candidates for named entities. The examples in FIGS. 9B-9D are sentences written in Finnish, Bulgarian, and Hebrew, respectively, each of which was used as an input sentence. The sentences were segmented into several substrings as indicated in the figures, each of which had corresponding object labels indicated in the figure. These substrings were recognized as candidates for named entities. As shown in FIGS. 9A-7D, it was demonstrated that the process can identify named entities in sentences written in several natural languages, including Indonesian, Finnish, Bulgarian, and Hebrew, without linguistic back ground knowledge about the sentence.

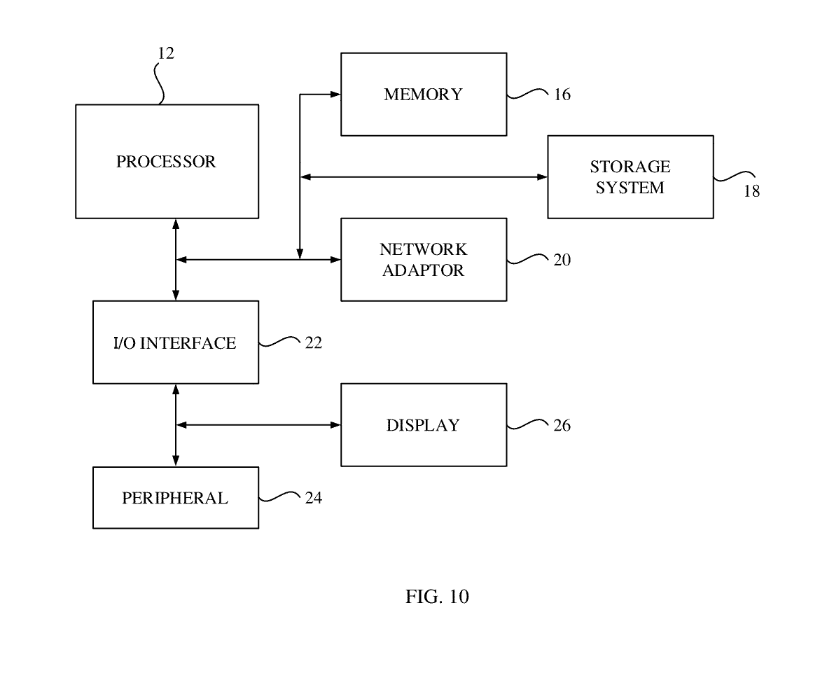

FIG. 10 is a diagram illustrating components of a computer system 10 for implementing the named entity recognition, in accordance with one embodiment of the present invention. The computer system 10 is used for implementing the named entity recognition engine 120. The computer system 10 is only one example of a suitable processing device and is not intended to suggest any limitation as to the scope of use or functionality of embodiments of the invention described herein. Regardless, the computer system 10 is capable of being implemented and/or performing any of the functionality set forth hereinabove.

The computer system 10 is operational with numerous other general purpose or special purpose computing system environments or configurations. Examples of well-known computing systems, environments, and/or configurations that may be suitable for use with the computer system 10 include, but are not limited to, personal computer systems, server computer systems, thin clients, thick clients, hand-held or laptop devices, in-vehicle devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 10 may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 10, the computer system 10 is shown in the form of a general-purpose computing device. The components of the computer system 10 may include, but are not limited to, a processor (or processing unit) 12 and a memory 16 coupled to the processor 12 by a bus including a memory bus or memory controller, and a processor or local bus using any of a variety of bus architectures.

The computer system 10 typically includes a variety of computer system readable media. Such media may be any available media that is accessible by the computer system 10, and it includes both volatile and non-volatile media, removable and non-removable media.

The memory 16 may include computer system readable media in the form of volatile memory, such as random access memory (RAM). The computer system 10 may further include other removable/non-removable, volatile/non-volatile computer system storage media. By way of example only, the storage system 18 can be provided for reading from and writing to a non-removable, non-volatile magnetic media. As will be further depicted and described below, the storage system 18 may include at least one program product having a set (e.g., at least one) of program modules that are configured to carry out the functions of embodiments of the invention.

Program/utility, having a set (at least one) of program modules, may be stored in the storage system 18 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

The computer system 10 may also communicate with one or more peripherals 24, such as a keyboard, a pointing device, a car navigation system, an audio system, a display 26, one or more devices that enable a user to interact with the computer system 10, and/or any devices (e.g., network card, modem, etc.) that enable the computer system 10 to communicate with one or more other computing devices. Such communication can occur via Input/Output (I/O) interfaces 22. The computer system 10 may communicate with one or more networks such as a local area network (LAN), a general wide area network (WAN), and/or a public network (e.g., the Internet) via the network adapter 20. As depicted, the network adapter 20 communicates with the other components of the computer system 10 via bus. It should be understood that although not shown, other hardware and/or software components may be used in conjunction with the computer system 10. Examples include but not limited to microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the C programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It is further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

Many modifications and variations may be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for extracting an expression in a text for natural language processing, the method comprising:
reading a text to generate a plurality of substrings, each substring including one or more units appearing in the text;
obtaining an image set for the each substring, the image set including one or more images, using the one or more units as a query for an image search system;
calculating a deviation in the image set for the each substring; and
selecting a respective one of the plurality of the substrings as an expression to be extracted, based on the deviation and a length of each substring.

2. The method of claim 1, further comprising:
obtaining one or more labels for the each substring based on a result of object recognition for the one or more images in the image set; and
calculating a number of different labels in the one or more labels obtained for the each substring;
wherein the number of the different labels used for calculating the deviation in the image set for the each substring.

3. The method of claim 2, further comprising:
calculating a bias of label distribution in the one or more labels obtained for the each substring; and
wherein the bias of the label distribution is used for calculating the deviation in the image set for the each substring.

4. The method of claim 2, further comprising:
counting a number of the one or more images in the image set for the each substring; and
wherein the number of the one or more images is used for calculating the deviation in the image set for the each substring.

5. The method of claim 2, further comprising:
estimating a type of the expression by using the one or more labels obtained for the respective one of the plurality of the substrings, the respective one of the plurality of the substrings being selected as the expression.

6. The method of claim 1, further comprising:
grouping the one or more images in the image set for the each substring into one or more groups, based on features of the one or more images; and
counting a number of the one or more groups obtained for the each substring, the number of the one or more groups counted for the each substring being used for calculating the deviation for the each substring.

7. The method of claim 1, further comprising:
scoring the plurality of the substrings such that a score becomes larger as the deviation for the each substring becomes smaller.

8. The method of claim 7, further comprising:
selecting one or more longer substrings having larger scores from the plurality of the substrings.

9. The method of claim 7, further comprising:
obtaining a number of search results for the each substring, a title of a page associated with each image for the each substring included in the each image for the each substring; and
adjusting the score in addition to the deviation for the each substring, using the number of search results and the title of the page associated with the each image.

10. The method of claim 1, further comprising:
performing the reading, the obtaining, the calculating and the selecting for each sentence of sentences in a collection; and
building a dictionary by using expressions extracted from the sentences in the collection.

11. A computer program product for extracting an expression in a text for natural language processing, the computer program product comprising a computer readable storage medium having program code embodied therewith, the program code executable to:
read a text to generate a plurality of substrings, each substring including one or more units appearing in the text;
obtain an image set for the each substring, the image set including one or more images, using the one or more units as a query for an image search system;
calculate a deviation in the image set for the each substring; and
select a respective one of the plurality of the substrings as an expression to be extracted, based on the deviation and a length of each substring.

12. The computer program product of claim 11, further comprising the program code executable to:
obtain one or more labels for the each substring based on a result of object recognition for the one or more images in the image set;
calculate a number of different labels in the one or more labels obtained for the each substring;
calculate a bias of label distribution in the one or more labels obtained for the each substring;
count a number of the one or more images in the image set for the each substring; and
estimate a type of the expression by using the one or more labels obtained for the respective one of the plurality of the substrings, the respective one of the plurality of the substrings being selected as the expression;
wherein the number of different labels, the bias of label distribution, and the number of the one or more images are used for calculating the deviation in the image set for the each substring.

13. The computer program product of claim 11, further comprising the program code executable to:
group the one or more images in the image set for the each substring into one or more groups, based on features of the one or more images; and
count a number of the one or more groups obtained for the each substring, the number of the one or more groups counted for the each substring being used for calculating the deviation for the each substring.

14. The computer program product of claim 11, further comprising the program code executable to:
score the plurality of the substrings such that a score becomes larger as the deviation for the each substring becomes smaller;
obtain a number of search results for the each sub string, a title of a page associated with each image for the each substring included in the each image for the each substring;
adjusting the score in addition to the deviation for the each substring, using the number of search results and the title of the page associated with the each image; and
select one or more longer substrings having larger scores from the plurality of the substrings.

15. The computer program product of claim 11, further comprising the program code executable to:
build a dictionary by using expressions extracted from a collection of sentences.

16. A computer system for extracting an expression in a text for natural language processing, the computer system comprising:
one or more processors, one or more computer readable tangible storage devices, and program instructions stored on at least one of the one or more computer readable tangible storage devices for execution by at least one of the one or more processors, the program instructions executable to:
read a text to generate a plurality of substrings, each substring including one or more units appearing in the text;
obtain an image set for the each substring, the image set including one or more images, using the one or more units as a query for an image search system;
calculate a deviation in the image set for the each substring; and
select a respective one of the plurality of the substrings as an expression to be extracted, based on the deviation and a length of each substring.

17. The computer system of claim 16, further comprising the program instructions executable to:
obtain one or more labels for the each substring based on a result of object recognition for the one or more images in the image set;
calculate a number of different labels in the one or more labels obtained for the each substring;
calculate a bias of label distribution in the one or more labels obtained for the each substring;
count a number of the one or more images in the image set for the each substring; and
estimate a type of the expression by using the one or more labels obtained for the respective one of the plurality of the substrings, the respective one of the plurality of the substrings being selected as the expression;
wherein the number of different labels, the bias of label distribution, and the number of the one or more images are used for calculating the deviation in the image set for the each substring.

18. The computer system of claim 16, further comprising the program instructions executable to:
group the one or more images in the image set for the each substring into one or more groups, based on features of the one or more images; and
count a number of the one or more groups obtained for the each substring, the number of the one or more groups counted for the each substring being used for calculating the deviation for the each substring.

19. The computer system of claim 16, further comprising the program instructions executable to:
score the plurality of the substrings such that a score becomes larger as the deviation for the each substring becomes smaller;
obtain a number of search results for the each sub string, a title of a page associated with each image for the each substring included in the each image for the each substring;
adjusting the score in addition to the deviation for the each substring, using the number of search results and the title of the page associated with the each image; and
select one or more longer substrings having larger scores from the plurality of the substrings.

20. The computer system of claim 16, further comprising the program instructions executable to:
build a dictionary by using expressions extracted from a collection of sentences.
